(19) United States
(12) Patent Application Publication
(10) Pub. No.: US 2014/0297722 A1
(43) Pub. Date: Oct. 2, 2014

(54) MEDIA MESSAGE SENDING METHOD, DEVICE AND SYSTEM

(71) Applicants: Xin Ding, Shenzhen City (CN); Yan Lu, Shenzhen City (CN)

(72) Inventors: Xin Ding, Shenzhen City (CN); Yan Lu, Shenzhen City (CN)

(73) Assignee: ZTE CORPORATION, Shenzhen City, Guangdong (CN)

(21) Appl. No.: 14/114,314

(22) PCT Filed: Jun. 5, 2012
(86) PCT No.: PCT/CN12/76480

§ 371 Date: Feb. 17, 2014

(30) Foreign Application Priority Data
Nov. 4, 2011 (CN) 201110345889.3

(51) Int. Cl. H04L 29/06

(52) U.S. Cl. CPC H04L 65/4023
USPC 709/203

(57) ABSTRACT

A method, device and system for sending media messages are disclosed in the present document. The method includes a media server receiving a media message which is delivered by a sending client through IMAP to a storage unit for the message to be sent pre-allocated to a sending user, the media server storing the received media message in the storage unit for message to be sent of the sending user, and the media server acquiring a media message unsent in the storage unit for message to be sent and forwarding the media message according to an identifier of a recipient user carried in the acquired media message. In such a fashion, it can be guaranteed that an IMAP client can possess the function of sending the messages, which reduces the complexity of implementing the terminal technology.

### TECHNICAL FIELD

The present document relates to the field of communication, and particularly, to a method, device and system for sending media messages.

### BACKGROUND OF THE RELATED ART

An Internet Message Access Protocol (IMAP) is an increasingly popular e-mail access protocol in recent years. With such protocol, a recipient can expediently acquire information of mails and download the required mails from a mail server. The IMAP provides functions of selectively receiving the mails for the recipient, that is, it is not necessary for the recipient to download an entire mail to acquire the related information (such as a mail subject and an addresser) of the mail, and only when the recipient selects a certain mail and wants to read contents of the mail, a client will download the specific contents of the mail from the server. In addition, through the IMAP, the recipient can maintain his/her mail directories in the server and can establish or change mailboxes in the server.

However, the IMAP does not provide services of sending the mail to a mailbox of the recipient. A sender can only send the mail to a mailbox of the sender in the server through an APPEND instruction of the IMAP at most. If the sender is required to send the mail to a specific recipient, according to the related art, the sender can only send the mail to the specific recipient through a Simple Mail Transfer Protocol (SMTP). Therefore, in order to send and receive the mail, a user equipment must simultaneously support two protocols, IMAP and SMTP, and install an IMAP client and an SMTP client, thereby increasing the complexity of the user equipment.

### SUMMARY OF THE INVENTION

The present document is disclosed with respect to the problem that a user equipment cannot send a mail to a recipient through IMAP in the related art, thus, the main object of the present document is to provide a method, device and system for sending media messages.

According to one aspect of the present document, a method for sending media messages is provided, which comprises: a media server receiving a media message which is delivered by a sending client through an Internet Message Access Protocol (IMAP) to a storage unit for message to be sent pre-allocated to a sending user; the media server storing the received media message in the storage unit for message to be sent of the sending user; and the media server acquiring a media message unsent in the storage unit for message to be sent, and forwarding the media message according to an identifier of a recipient user carried in the acquired media message.

Preferably, the step of the media server forwarding the media message according to an identifier of a recipient user carried in the acquired media message comprises: the media server forwarding the media message through a Simple Mail Transfer Protocol (SMTP) according to the identifier of the recipient user, or transferring the media message to a storage unit allocated to the recipient user within the media server.

Preferably, the step of a media server receiving a media message which is delivered by a sending client through an IMAP to a storage unit for message to be sent of the sending client comprises: the media server receiving the media message delivered by the sending client to the storage unit for message to be sent through an APPEND instruction of the IMAP.

Preferably, the step of the media server acquiring a media message unsent in the storage unit for message to be sent, and forwarding the media message according to an identifier of a recipient user carried in the acquired media message comprises: the media server scanning the storage unit for message to be sent at regular intervals, acquiring the media message unsent in the storage unit for message to be sent, and forwarding the media message according to the identifier of the recipient user carried in the acquired media message.

Preferably, the step of the media server acquiring a media message unsent in the storage unit for message to be sent, and forwarding the media message according to an identifier of a recipient user carried in the acquired media message comprises: when the storage unit for message to be sent of the media server receives the media message delivered by the sending client, the media server forwarding the media message according to the identifier of the recipient user carried in the media message.

According to another aspect of the present document, a device for sending media messages is provided, which is located at a media server side and comprises: a receiving unit, configured to receive a media message which is delivered by a sending client through an Internet Message Access Protocol (IMAP) to a storage unit for message to be sent pre-allocated to a sending user; the storage unit for message to be sent, configured to store the media message received by the receiving unit; an acquisition unit, configured to acquire a media message unsent in the storage unit for message to be sent; and a sending unit, configured to forward the media message according to an identifier of a recipient user carried in the media message acquired by the acquisition unit.

Preferably, the sending unit forwards the media message through a Simple Mail Transfer Protocol (SMTP) according to the identifier of the recipient user, or transfers the media message to a storage unit allocated to the recipient user within the media server.

Preferably, the acquisition unit is configured to scan the storage unit for message to be sent at regular intervals and acquire the media message unsent in the storage unit for message to be sent.

Preferably, the storage unit for message to be sent is further configured to trigger the acquisition unit when receiving the media message delivered by the client.

According to another aspect of the present document, a system for sending media messages is provided, which comprises: a sending client, configured to deliver a media message to a media server through an Internet Message Access Protocol (IMAP), wherein, the media message is a media message delivered to a storage unit for message to be sent pre-allocated to a sending user, and the media message carries an identifier of a recipient user; and the media server, comprising the above device.

Preferably, the sending client delivers the media message through an APPEND instruction of the IMAP.

In the invention, a sender can send media message to a media server to which the sender belongs through the IMAP, and the media server stores the media message in a storage unit for message to be sent of a sending user, and forwards the media message according to an identifier of a recipient carried in the media message, thus the sender is enabled to send the media message to the receiver through the media server in a situation that only the IMAP is supported, which reduces the complexity of the user equipment.

### BRIEF DESCRIPTION OF DRAWINGS

Here, the described accompanying drawings are used to provide a further understanding of the present document and constitute a part of the present application. The schematic examples and illustrations thereof of the present document are used to explain the invention, but not to constitute an inappropriate limitation of the invention. In the drawings:

FIG. 1 is a flow diagram of a method for sending media messages according to the example of the present document.

FIG. 2 is a flow diagram of a method for sending media messages according to the preferred example 1 of the present document.

FIG. 3 is a flow diagram of a method for sending media messages according to the preferred example 2 of the present document.

FIG. 4 is a block diagram of structure of a device for sending media messages according to the example of the present document.

FIG. 5 is a schematic diagram of structure of a system for sending media messages according to the example of the present document.

### PREFERRED EMBODIMENTS OF THE INVENTION

It should be noted that the examples in the present document and the characteristics in the examples can be combined with each other in the condition of no conflict. The present document will be described in detail with reference to the accompanying drawings and in combination with the examples below.

A method for sending media messages through IMAP is provided, and with the method in the example of the present document, a user equipment is enabled to send and receive mails (i.e. the media messages) when only an IMAP client is required to be installed on the user equipment. In the example of the present document, a media server can set a mailbox used for storing media messages to be sent (i.e. a storage unit for message to be sent corresponding to a sending user, which is hereinafter called as “a mailbox to be sent” for short) for a sender; after an IMAP client of the sending user is authenticated successfully (through the existing IMAP authentication mechanism), the mailbox to be sent can be accessed; in the example of the present document, when the sender is required to send a certain media message, the client sends the media message to be sent of the sender to the mailbox to be sent of the sender through the IMAP (e.g., an APPEND instruction), and if the client delivers a new media message and the media message carries an identifier of a recipient, the media server sends the media message to a recipient specified in the media message. For example, the media message can directly send the media message to a mailbox of a recipient user within the media server (with regard to a situation that the recipient user and the sending user belong to the same media server), or the media server sends the media message to a media server to which the recipient user belongs through an SMTP (with regard to a situation that the recipient user and the sending user belong to different media servers).

FIG. 1 is a flow diagram of a method for sending media messages according to the example of the present document, and as shown in FIG. 1, the method for sending the media messages mainly includes step S102 to step S106.

In step S102, a media server receives a media message which is delivered by a sending client through an Internet Message Access Protocol (IMAP) to a storage unit for message to be sent pre-allocated to a sending user.

For example, the sending client can send a media message to a mailbox to be sent of the sending client through an APPEND instruction of the IMAP, and the APPEND instruction can carry an identifier of the sending user. Meanwhile, if the sender is required to send the media message to a specified recipient, the sender also can carry an identifier of the recipient in the media message.

Before executing the step S102, in a preferred embodiment of the example of the present document, the media server can firstly perform authentication on the sender, thus interference from an illegal user to the media server is avoided, so that the server obtain better management. Then, after the authentication, the media server also can establish a mailbox of the sender for a sender which is authenticated successfully (that is, the storage unit for message to be sent corresponding to the sending user is allocated), which is used for sending the media messages.

In step S104, the media server stores the received media message in the storage unit for message to be sent of the sending user.

After receiving the media message delivered by the sender to a mailbox to be sent of the sender, the media server stores the media message in the storage unit for message to be sent of the sending user (i.e. the mailbox to be sent), which serves as the media message to be sent.

In step S106, the media server acquires a media message unsent in the storage unit for message to be sent, and forwards the media message according to an identifier of a recipient user carried in the acquired media message.

The media server of the example of the present document can periodically scan media messages in the storage unit for message to be sent, and it judges whether an unsent media message is stored in the storage unit for message to be sent, if yes, the media message is forwarded according to the identifier of the recipient user carried in the media message. Or, the media server also can scan the media message stored in the storage unit for message to be sent when detecting a predetermined triggering event, and it judges whether an unsent media message is stored in the storage unit for message to be sent, if yes, the media message is forwarded according to the identifier of the recipient user carried in the media message. For example, when the storage unit for message to be sent receives the media message delivered by the sending client, the media server can forward the media message according to the identifier of the recipient user carried in the media message.

In the example of the present document, the media server can forward the media message through the SMTP, and it also can forward the media message in other ways, which is not specifically limited in the example of the present document.

In the related art, the sender cannot send the media message to the mailbox of the recipient through the IMAP, and it can only depend on other protocols, such as the SMTP. In the example of the present document, the sender delivers the media message to the media server through the IMAP, then the media server forwards the media message, and thus the media message is sent to the recipient, which implements sending of the media message.

For example, in a situation that the media server to which the mailbox of the sender belongs and the media server to which the mailbox of the recipient belongs are the same, the media server can directly send the media message to the storage unit corresponding to the recipient (i.e. the mailbox). In a situation that the media server to which the mailbox of the sender belongs and the media server to which the mailbox of the recipient belongs are different, after the media message is interacted between the media server to which the mailbox of the sender belongs and the media server to which the mailbox of the recipient belongs, the media server to which the mailbox of the recipient belongs sends the media message to the mailbox of the recipient. Through the example, with regard to the mailbox of the sender and the mailbox of the recipient in the same media server, the media message is directly forwarded, and the implementation way thereof is convenient and reliable. With regard to the mailbox of the sender and the mailbox of the recipient in the different media servers, the media server to which the mailbox of the sender belongs and the media server to which the mailbox of the recipient belongs perform the interaction of the media message through the Simple Mail Transfer Protocol (SMTP), and the media message is delivered to the mailbox of the recipient, thereby implementing that the media message is sent across the media servers.

After the step S106, the recipient also can acquire the media message from the mailbox of the recipient through the IMAP, which is easy for the user to use and improves the user experience.

The technical scheme of the present document will be further described in detail in combination with the accompanying drawings and specific examples below.

### EXAMPLE 1

In the example, a recipient user and a sending user belong to the same media server, and the sending user sends a media message to be sent of the sender to a mailbox to be sent of the sender in the media server through an APPEND instruction of the IMAP, and then the media server directly transmits the media message to a mailbox of the recipient user within the media server.

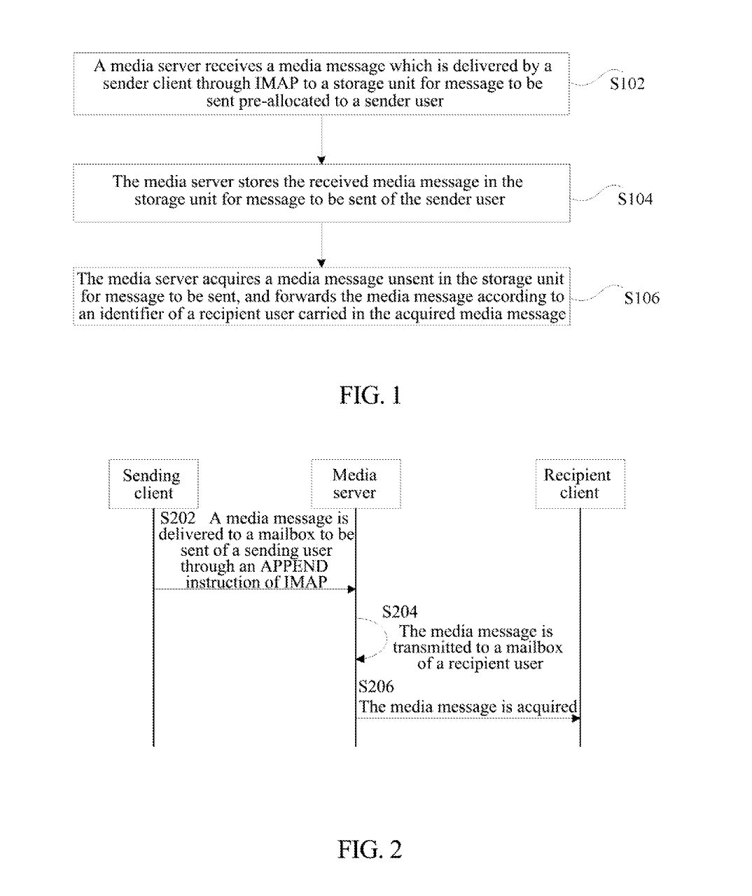

FIG. 2 is a flow diagram of a method for sending media messages according to the example 1 of the present document. As shown in FIG. 2, in the example, sending the media messages can include steps S202 to S206.

In step S202, after an IMAP client of the sending user is successfully authenticated by the server, the IMAP client delivers a locally established media message of the sender to the mailbox to be sent of the sending user in the media server through the APPEND instruction of the IMAP.

The APPEND instruction can carry the media message and a name of the mailbox to be sent of the sending user, wherein, the media message can carry an identifier of the recipient user.

In step S204, after successfully receiving the media message in step S202, the media server determines that the recipient user belongs to the current media server according to the identifier of the recipient user carried in the media message, and transmits the media message from the mailbox to be sent of the sending user to the mailbox of the recipient user in the current media server; and this process is a process within the media server.

In step S206, the recipient user acquires the media message from the mailbox of the recipient user through the IMAP.

### EXAMPLE 2

In the example, the recipient user and the sending user belong to two different media servers, the sender user sends the media message to be sent of the sender to the mailbox to be sent of the sender in the media server through the APPEND instruction of the IMAP, and then the media server sends the media message to a media server to which the recipient user belongs through an SMTP.

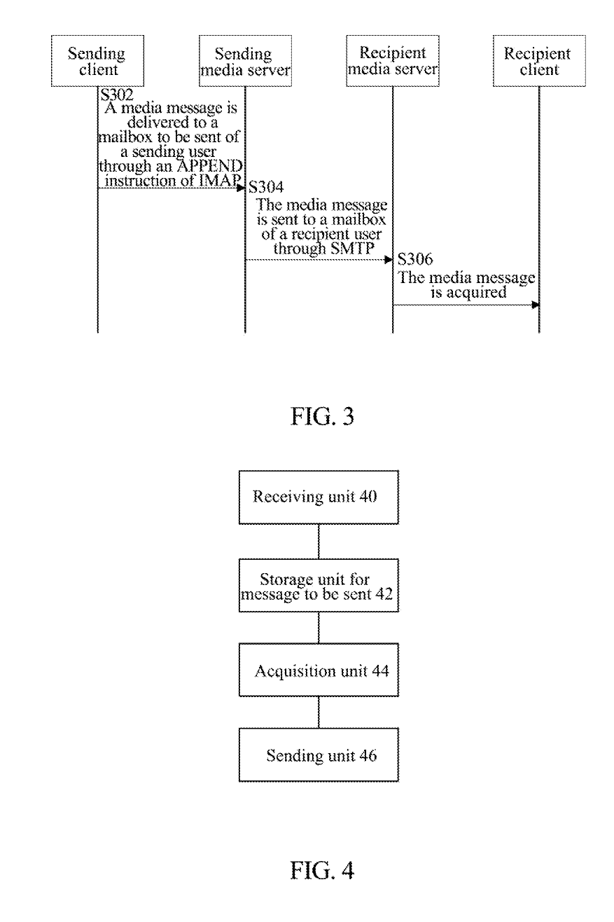

FIG. 3 is a flow diagram of a method for sending media messages according to the example 2 of the present document. As shown in FIG. 3, in the example, sending the media messages can include steps S302 to S306.

In step S302, after an IMAP client of the sending user is successfully authenticated, the IMAP client delivers a locally established media message of the sender to the mailbox to be sent of the sending user in the media server through the APPEND instruction of the IMAP. Wherein, the APPEND instruction carries the media message and a name of the mailbox to be sent; and the media message carries an identifier of the recipient user.

In step S304, after successfully receiving the media message in step S302, the media server of the sender determines a media server to which the recipient user belongs according to the identifier of the recipient user carried in the media message, and then it performs SMTP signaling interaction with the media server to which the recipient user belongs, and sends the media message from the mailbox to be sent of the sending user in the media server of the sender to the mailbox of the recipient user in the media server to which the recipient belongs.

In step S306, the recipient user acquires the media message from the mailbox of the recipient user through the IMAP.

It should be noted that, the steps shown in the flow diagrams of the accompanying drawings can be executed in the computer system with a group of computer executable instructions, and though the logic sequence is shown in the flow diagrams, in some cases, the illustrated and described steps can be executed in a sequence different from herein.

A device for sending media messages is also provided in the present document, and the device for sending media messages can be located at the above media server side, which is used for implementing the above method for sending media messages. FIG. 4 is a block diagram of structure of the device for sending media messages according to the example of the present document, and as shown in FIG. 4, a receiving unit 40, a storage unit for message to be sent 42 corresponding to a sending user, an acquisition unit 44 and a sending unit 46 are included. The device will be described in detail below.

The receiving unit 40 is configured to receive a media message which is delivered by a sending client through an Internet Message Access Protocol (IMAP) to a storage unit for message to be sent pre-allocated to a sending user; the storage unit for message to be sent 42 is connected with the receiving unit 40 and is configured to store the media message received by the receiving unit 40; the acquisition unit 44 is connected with the storage unit for message to be sent 42 and is configured to acquire a media message unsent in the storage unit for message to be sent 42; and the sending unit 46 is connected with the acquisition unit 44 and is configured to forward the media message according to an identifier of a recipient user carried in the media message acquired by the acquisition unit 44.

In a preferred embodiment of the example of the present document, the sending unit 46 can forward the media message through a Simple Mail Transfer Protocol (SMTP) according to the identifier of the recipient user. For example, the sending unit 46 can interact with a media server to which the recipient user belongs through the ways described in the above example of the method, and thus the media message is forwarded to the recipient. Or, if the recipient user and the sending user belong to the same media server, the sending unit 46 can transmit the media message to a storage unit allocated to the recipient user within the media server.

In a preferred embodiment of the example of the present document, the acquisition unit 44 is configured to scan the storage unit for message to be sent 42 at regular intervals, and acquire the media message unsent in the storage unit for message to be sent 42.

In another preferred embodiment of the example of the present document, the storage unit for message to be sent 42 is further configured to trigger the acquisition unit 44 when receiving the media message delivered by the client. The acquisition unit 44 acquires a media message newly delivered to the storage unit for message to be sent 42 under the triggering of the storage unit for message to be sent 42, and the sending unit 46 forwards the media message according to the identifier of the recipient user carried in the media message.

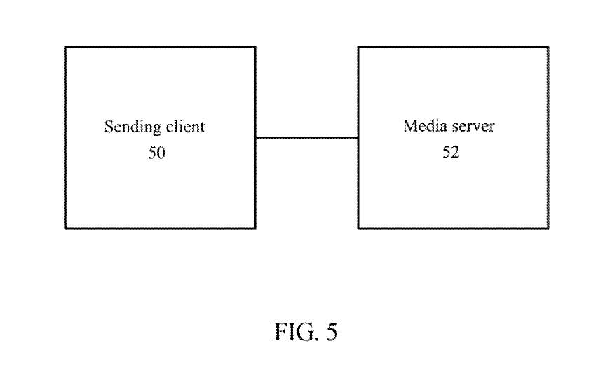

FIG. 5 is a schematic diagram of structure of a system for sending media messages according to the example of the present document, and the system can be configured to implement the above method for sending media messages provided in the example of the present document. As shown in FIG. 5, the system includes: a sending client 50, configured to deliver a media message to a media server 52 through an Internet Message Access Protocol (IMAP), wherein, the media message is a media message delivered to a storage unit for message to be sent pre-allocated to a sending user, and the media message carries an identifier of a recipient user; and the media server 52, including the device for sending media messages mentioned in the above example.

In a preferred embodiment of the example of the present document, the sending client 50 can deliver the media message through an APPEND instruction of the IMAP.

In conclusion, in the above one or more examples of the present document, a sender can send the media message to a media server to which the sender belongs through the IMAP, and the media server stores the media message in a storage unit for message to be sent corresponding to a sender, and forwards the media message according to an identifier of a recipient carried in the media message, thus the sender is enabled to send the media message to the recipient through the media server in a situation that only the IMAP is supported, which reduces the complexity of the user equipment.

Apparently, the skilled in the art should understand that the modules or steps of the present document mentioned above can be implemented through a universal calculating device, and they can be concentrated on a single calculating device or distributed in a network consisting of multiple calculating devices. Alternatively, the modules or steps can be implemented through program codes which can be executed by the calculating device, thus, they can be stored in a storage device to be executed by the calculating device, or they can be made into multiple integrated circuit modules or multiple modules or steps of them can be made into a single integrated circuit module to be implemented. Therefore, the invention is not limited to any combination of hardware and software in a specific form.

The above description is only the preferred examples of the invention, which is not used to limit the invention. The invention can have various modifications and changes for the skilled in the art. All the modifications, equivalent substitutions, and improvements and so on made within the spirit and principle of the invention shall fall into the protection scope of the invention.

1. A method for sending media messages, comprising following steps of:
a media server receiving a media message which is delivered by a sending client through an Internet Message Access Protocol (IMAP) to a storage unit for message to be sent pre-allocated to a sending user;
the media server storing the received media message in the storage unit for message to be sent of the sending user; and
the media server acquiring a media message unsent in the storage unit for message to be sent, and forwarding the media message according to an identifier of a recipient user carried in the acquired media message.

2. The method according to claim 1, wherein, the step of the media server forwarding the media message according to an identifier of a recipient user carried in the acquired media message comprises:
the media server forwarding the media message through a Simple Mail Transfer Protocol (SMTP) according to the identifier of the recipient user, or transferring the media message to a storage unit allocated to the recipient user within the media server.

3. The method according to claim 1, wherein, the step of a media server receiving a media message which is delivered by a sending client through an IMAP to a storage unit for message to be sent comprises: the media server receiving the media message which is delivered by the sending client through an APPEND instruction of the IMAP to the storage unit for message to be sent.

4. The method according to claim 1, wherein, the step of the media server acquiring a media message unsent in the storage unit for message to be sent, and forwarding the media message according to an identifier of a recipient user carried in the acquired media message comprises:
the media server scanning the storage unit for message to be sent at regular intervals, acquiring the media message unsent in the storage unit for message to be sent, and forwarding the media message according to the identifier of the recipient user carried in the acquired media message.

5. The method according to claim 1, wherein, the step of the media server acquiring a media message unsent in the storage unit for message to be sent, and forwarding the media message according to an identifier of a recipient user carried in the acquired media message comprises:
when the storage unit for message to be sent of the media server receives the media message delivered by the sending client, the media server forwarding the media message according to the identifier of the recipient user carried in the media message.

6. A device for sending media messages, located at a media server side, comprising:
a receiving unit, configured to receive a media message which is delivered by a sending client through an Internet Message Access Protocol (IMAP) to a storage unit for message to be sent pre-allocated to a sending user;
the storage unit for message to be sent, configured to store the media message received by the receiving unit;
an acquisition unit, configured to acquire a media message unsent in the storage unit for message to be sent; and
a sending unit, configured to forward the media message according to an identifier of a recipient user carried in the media message acquired by the acquisition unit.

7. The device according to claim 6, wherein, the sending unit forwards the media message through a Simple Mail Transfer Protocol (SMTP) according to the identifier of the recipient user, or transfers the media message to a storage unit allocated to the recipient user within the media server.

8. The device according to claim 6, wherein, the acquisition unit is configured to scan the storage unit for message to be sent at regular intervals and acquire the media message unsent in the storage unit for message to be sent.

9. The device according to claim 6, wherein, the storage unit for message to be sent is further configured to trigger the acquisition unit when receiving the media message delivered by the client.

10. A system for sending media messages, comprising:
a sending client, configured to deliver a media message to a media server through an Internet Message Access Protocol (IMAP), wherein, the media message is a media message delivered to a storage unit for message to be sent pre-allocated to a sending user, and the media message carries an identifier of a recipient user; and
the media server, comprising the device according to any one of claims 64e-9.

11. The system according to claim 10, wherein, the sending client delivers the media message through an APPEND instruction of the IMAP.

12. The method according to claim 2, wherein, the step of the media server acquiring a media message unsent in the storage unit for message to be sent, and forwarding the media message according to an identifier of a recipient user carried in the acquired media message comprises:
the media server scanning the storage unit for message to be sent at regular intervals, acquiring the media message unsent in the storage unit for message to be sent, and forwarding the media message according to the identifier of the recipient user carried in the acquired media message.

13. The method according to claim 3, wherein, the step of the media server acquiring a media message unsent in the storage unit for message to be sent, and forwarding the media message according to an identifier of a recipient user carried in the acquired media message comprises:
the media server scanning the storage unit for message to be sent at regular intervals, acquiring the media message unsent in the storage unit for message to be sent, and forwarding the media message according to the identifier of the recipient user carried in the acquired media message.

14. The method according to claim 2, wherein, the step of the media server acquiring a media message unsent in the storage unit for message to be sent, and forwarding the media message according to an identifier of a recipient user carried in the acquired media message comprises:
when the storage unit for message to be sent of the media server receives the media message delivered by the sending client, the media server forwarding the media message according to the identifier of the recipient user carried in the media message.

15. The method according to claim 3, wherein, the step of the media server acquiring a media message unsent in the storage unit for message to be sent, and forwarding the media message according to an identifier of a recipient user carried in the acquired media message comprises:
when the storage unit for message to be sent of the media server receives the media message delivered by the sending client, the media server forwarding the media message according to the identifier of the recipient user carried in the media message.
